(19) United States
(12) Patent Application Publication
(10) Pub. No.: US 2009/0184997 A1
(43) Pub. Date: Jul. 23, 2009

(54) DROPLET DISCHARGE DEVICE

(75) Inventor: Yuji IWATA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/352,634

(22) Filed: Jan. 13, 2009

(30) Foreign Application Priority Data
Jan. 23, 2008 (JP) 2008-012296

(51) Int. Cl. B41J 2/165

(52) U.S. Cl. 347/31

(57) ABSTRACT

A droplet discharge device includes: a droplet discharge head attached to a carriage, a stage placing a substrate thereon, and a moisture adsorption device disposed adjacent to the droplet discharge head. In the device, a droplet of a functional liquid containing a functional material is sequentially discharged from the droplet discharge head to the substrate so as to draw a pattern on a surface of the substrate while the droplet discharge head moves relative to the substrate.

### BACKGROUND

1. Technical Field

The present invention relates to a droplet discharge device.

2. Related Art

A low temperature co-fired ceramics (LTCC) technique allows a collective firing of a green sheet and metal, realizing an element built-in substrate in which various types of passive elements are built in between ceramic layers. In terms of a mounting technique of system on package (SOP), a manufacturing method relating to the element built-in substrate (hereinafter simply referred to as an LTCC multilayer substrate) has been devotedly developed in order to combine electronic components and minimize parasitic effect occurring at surface mounting components.

In the method for manufacturing the LTCC multilayer substrate, a drawing step, a pressure bonding step, and a firing step are sequentially conducted. In the drawing step, patterns of passive elements and wiring lines are drawn on each of a plurality of green sheets. In the pressure bonding step, the plurality of green sheets having the patterns are laminated to be pressure-bonded. In the firing step, a pressure bonded body obtained through the pressure bonding step is fired collectively.

For the drawing step, JP-A-2005-57139, as an example of related art, suggests an ink jet method in which a conductive ink is discharged as fine droplets so as to densify various patterns. According to the ink jet method, patterns are drawn by using a droplet discharge device with droplets ranging from several picoliters to several dozen picoliters. Therefore, changing of discharging position of the droplet allows miniaturizing patterns or narrowing pitches.

Then, in order to form high precision patterns, a new droplet is preferably landed after a previous droplet landed on the green sheet is dried in a short time. Accordingly, the green sheet is heated to raise the temperature of the green sheet so as to increase the drying speed of the droplet landed thereon.

Here, the green sheet on which patterns of passive elements and wiring lines are drawn by the droplet discharge device includes much moisture. Therefore, steam is produced from the green sheet while the green sheet is heated so as to draw the patterns. The produced steam stays on the surface of the green sheet so that it prevents the landed droplet from drying. As a result, the drying speed of the landed droplet is decreased, and the operational efficiency of the drawing step is lowered.

### SUMMARY

An advantage of the invention is to provide a droplet discharge device that can accelerate drying a droplet landed on a substrate and improve operational efficiency.

A droplet discharge device of the invention includes: a droplet discharge head attached to a carriage; a stage placing a substrate thereon; and a moisture adsorption device disposed adjacent to the droplet discharge head. In the device, a droplet of a functional liquid containing a functional material is sequentially discharged from the droplet discharge head to the substrate so as to draw a pattern on a surface of the substrate while the droplet discharge head moves relative to the substrate.

According to the droplet discharge device, the moisture adsorption device and the droplet discharge head may move relative to the substrate and pass through the surface of the substrate. At this time, the steam staying on the surface of the substrate may adsorb to the moisture adsorption device. It may enable the surface of the substrate to be into a dry condition. Therefore, drying the droplet landed on the substrate discharged from the discharge head may be accelerated.

In the droplet discharge device, the moisture adsorption device may be disposed adjacent to one of a first side of the droplet discharge head in a droplet discharge head relative movement direction and a second side of the droplet discharge head in a direction opposite to the droplet discharge head relative movement direction. According to the droplet discharge device, the moisture adsorption device can be passed through a position before the droplet landed or after landed. The landed droplet can be dried efficiently and securely.

In the droplet discharge device, a heating unit for heating the substrate may be provided on the stage. According to the droplet discharge device, moisture in the steam staying on the surface of the substrate may adsorb to the moisture adsorption device. The steam is generated by heat from moisture contained in the substrate.

In the droplet discharge device, the substrate may be a low-temperature firing sheet including ceramic particles and resin, and the functional liquid is a metal ink liquid in which metal particles serving as the functional material are dispersed.

According to the droplet discharge device, the moisture adsorption device may accelerate drying the droplet of the metal ink which is discharged from the droplet discharge head and landed on the low-temperature firing sheet. In the droplet discharge device, the moisture adsorption device may include a container having air holes and moisture adsorption particles stored in the container.

According to the droplet discharge device, the moisture in the steam may adsorb to the moisture adsorption particles stored in the container through the air holes of the container. The moisture adsorption particles may be made of silica gel.

According to the droplet discharge device, silica gel may absorb and hold moisture of the steam.

### BRIEF DESCRIPTION OF THE DRAWINGS

The invention will be described with reference to the accompanying drawings, wherein like numbers reference like elements.

FIG. 1 is a sectional side view of a circuit module.

FIG. 2 is a whole perspective view of a droplet discharge device.

FIG. 3 is a sectional side view of a principal section of a droplet discharge head.

FIG. 4 is a perspective bottom view of the droplet discharge head.

### DESCRIPTION OF EXEMPLARY EMBODIMENTS

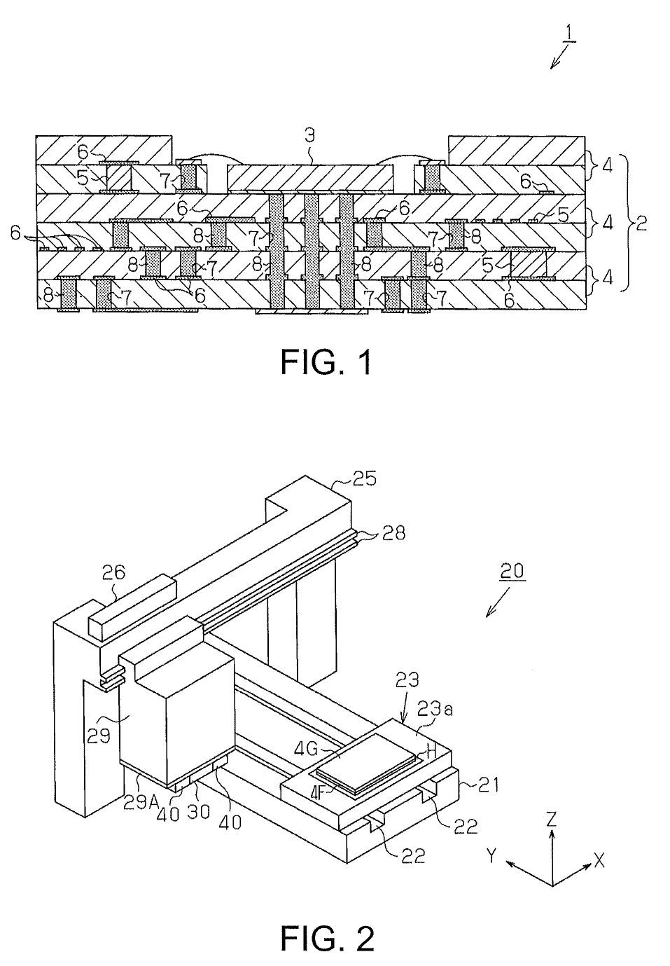

An embodiment of the invention will be described with reference to FIG. 1 to 4. In a circuit module in which a semiconductor chip is built in a low temperature co-fired ceramic (LTCC) multilayer substrate, the invention is embodied in forming wiring patterns drawn on a plurality of low-temperature firing sheets (green sheets) forming the LTCC multilayer substrate.

First, the circuit module will be explained in which the semiconductor chip is mounted on the LTCC multilayer substrate. FIG. 1 is a sectional view of a circuit module 1. The circuit module 1 includes an LTCC multilayer substrate 2 and a semiconductor chip 3. The LTCC multilayer substrate 2 is formed into a plate shape. The semiconductor chip 3 is connected to an upper side of the LTCC multilayer substrate 2 by wire bonding.

The LTCC multilayer substrate 2 is a laminated body of a plurality of low-temperature fired substrates 4 each of which is formed into a sheet shape. Each of the low-temperature fired substrates 4 is a sintered body (porous substrates) formed from a glass ceramic material (for example, a mixture of a glass component, such as borosilicic acid alkali oxide and a ceramic component, such as alumina). A thickness of each low-temperature fired substrate 4 is several hundred micrometers.

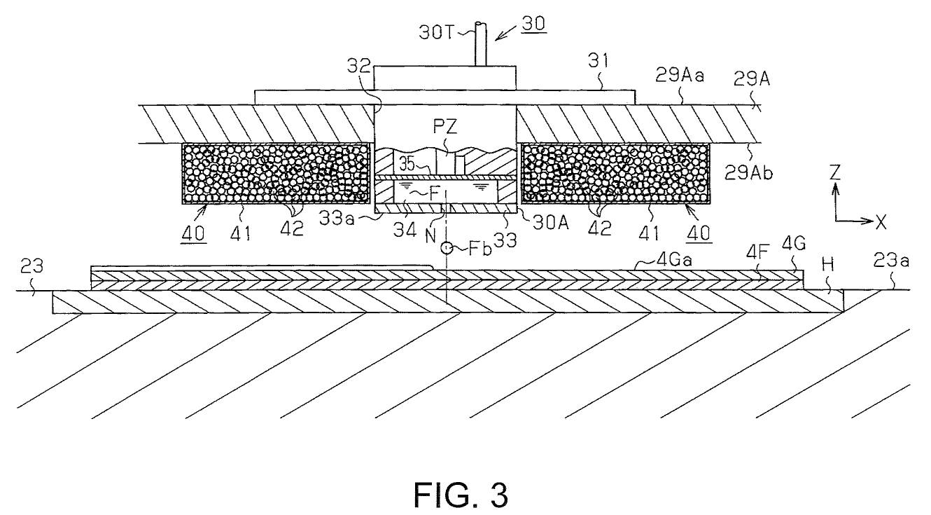

Then, as for the low-temperature fired substrate 4, one before firing is referred to as a green sheet 4G (refer to FIGS. 2 and 3) for the low-temperature firing sheet. The green sheet 4G is a substrate which obtains such that powder of a glass ceramic based material and a dispersion medium are mixed with a binder, a foam stabilizer, and the like so as to make a slurry, and the slurry is shaped in a plate shape and dried.

In each low-temperature fired substrate 4, various circuit elements 5, internal wiring lines 6, a plurality of via holes 7, and via wiring lines 8 are each formed accordingly based on a circuit design. The various circuit elements 5 include a resistive element, a capacitive element, a coil element, and the like. The internal wiring lines 6 electrically connect each circuit element 5. The via holes 7 have a predetermined hole diameter (such as 20 micrometers) and serve as a stack via structure or a thermal via structure. The via holes 7 are filled with the via wiring lines 8.

Each internal wiring line 6 of each low-temperature fired substrate 4 is a sintered body formed from metal microparticles of metal, such as silver and silver alloys. The internal wirings 6 are formed by a wiring pattern forming method using a droplet discharge device 20 as shown in FIG. 2 as a pattern forming device.

FIG. 2 is a whole perspective view of the droplet discharge device 20. The droplet discharge device 20 includes a rectangular parallelepiped base 21. A pair of guiding grooves 22 extending in a longitudinal direction (an arrow Y direction) are formed on an upper surface of the base 21. A stage 23 is provided above the guide grooves 22. The stage 23 moves in the arrow Y direction and a direction opposite to the arrow Y direction along the guide grooves 22.

The green sheet 4G which is the low-temperature fired substrate 4 before firing is placed on the stage 23. A carrier film 4F is releasably bounded to a back surface of the green sheet 4G placed on the stage 23.

The carrier film 4 supports the green sheet 4G in the drawing step and in subsequent steps. The carrier film may be a plastic film having, for example, a peeling property with respect to the green sheet 4G and an excellent mechanical resistance in each of the steps. The carrier film 4F may be a polyethylene terephthalate film, a polyethylene naphthalate film, a polyethylene film, and a polypropylene film.

The green sheet 4G is a layer made of a glass ceramic composition containing glass ceramic powder, a binder, and the like. The green sheet 4G is formed a layer having a thickness of several dozen μm in a case where a capacitor element is formed as the circuit element 5, and a thickness of 100 μm to 200 μm in other layers. The green sheet 4G is formed by a sheet forming method, such as a doctor blade method or a reverse roll coater method. The green sheet 4G is obtained by applying a glass ceramic composition that is slurried by a dispersion medium on the carrier film 4F and drying the applied film until the film becomes to be able to be handled.

The dispersion medium can be a surfactant or a silane coupling agent, for example. Any dispersion medium can be used as long as it evenly disperses glass ceramic powder. The glass ceramic power has an average particle diameter of 0.1 μm to 5 μm, and can be glass composite ceramic in which borosilicate glass is mixed with ceramic powder, such as alumina, forsterite, or the like. The glass ceramic powder can be made of crystallized glass ceramic containing ZnO—MgO—Al₂O₃—SiO₂ crystallized glass or non-vitreous ceramic containing BaO—Al₂O₃—SiO₂ ceramic powder or Al₂O₃—CaO—SiO₂—MgO—B₂O₃ ceramic powder.

The binder functions as a binding material of the glass ceramic powder, and is an organic polymer that is decomposed in the subsequent firing step so as to be easily removed. The binder may be made of binder resin, such as butyral resin, acrylic resin, and cellulose resin. The acrylic binder resin can be a homopolymer of a (metha)acrylate compound such as alkyl(metha)acrylate, alkoxyalkyl(metha)acrylate, polyalkylene glycol(metha)acrylate, and cycloalkyl(metha)acrylate. Further, the acrylic binder resin can be a copolymer obtained two or more types of the (metha)acrylate compounds or a copolymer including a (metha)acrylate compound and other copolymerizable monomer of unsaturated carbonic acids.

The binder may contain a plasticizer, such as adipate ester plasticizer, dioctylphthalate (DOP), dibutylphthalate (DBP), phthalate ester plasticizer, and glycol ester plasticizer.

On an upper surface 23a of the stage 23, a rubber heater H as a heating unit is provided. The green sheet 4G placed on the stage 23 is heated to a predetermined temperature by the rubber heater H. The green sheet 4G placed on the stage 23 is fixed at a position with respect to the stage 23, and the green sheet 4G is carried in the arrow Y direction and the direction opposite to the arrow Y direction.

As shown in FIG. 2, a gate-shaped guiding member 25 stands over the base 21. The guiding member 25 straddles the base 21 in a direction (an arrow X direction) perpendicular to the arrow Y direction. On an upper surface of the guiding member 25, an ink tank 26 is disposed extending in the arrow X direction. The ink tank 26 stores a metal ink F (refer to FIG. 3), and the ink tank 26 supplies a droplet discharge head (hereinafter simply referred to as a discharge head) 30 with the stored metal ink F by applying a predetermined pressure. The metal ink F supplied to the discharge head 30 is discharged from the discharge head towards the green sheet 4G as a droplet Fb (see FIG. 3).

The metal ink F can be a dispersive metal ink, in which metal microparticles, for example, having a diameter of a few nm serving as a functional material are dispersed in a solvent. Examples of the metal microparticles for the metal ink F include gold (Au), silver (Ag), copper (Cu), aluminum (Al), palladium (Pd), manganese (Mn), titanium (Ti), tantalum (Ta), nickel (Ni), oxides of these, microparticles of a superconductor, and the like. Preferably, the metal microparticles have a diameter of 1 nm to 0.1 μm. If the diameter is larger than 0.1 μm, any discharge nozzle N of the discharge head 30 may be clogged. Additionally, if the diameter is smaller than 1 nm, a volume ratio of a dispersant to the metal microparticles becomes greater, thereby excessively increasing the ratio of an organic substance in an obtained film.

Any dispersion medium that is capable of dispersing the above described metal microparticles and does not cause an aggregation can be used. Examples of the dispersion medium may include: aqueous solvents; alcohols, such as methanol, ethanol, propanol, and butanol; hydrocarbon compounds, such as n-heptane, n-octane, decane, dodecane, tetradecane, toluene, xylene, cymene, durene, indene, dipentene, tetrahydronaphthalene, decahydronaphthalene, and cyclohexylbenzene; polyols, such as ethylene glycol, diethylene glycol, triethylene glycol, glycerin, and 1,3-propanediol; ether compounds, such as polyethylene glycol, ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis(2-methoxyethyl)ether, and p-dioxane; and polar compounds, such as propylene carbonate, gamma-butyrolactone, N-methyl-2-pyrrolidone, dimethylformamide, dimethyl sulfoxide, cyclohexanone, and ethyl lactate. Water, alcohols, hydrocarbon compounds, and ether compounds are preferably used in terms of particulate dispersibility, dispersion-liquid stability, and applicability to droplet discharge. Water and hydrocarbon compounds are used more preferably.

After the metal ink F lands on the green sheet 4G, a solvent or a part of a dispersion medium of the metal ink F evaporates from the surface. At this time, the green sheet 4G is heated so as to accelerate the evaporation of the solvent or the dispersion medium.

Then, the metal ink F landed on the green sheet 4 increases its viscosity from the outer edge of the surface as it is dried. That is, the concentration of solid matter (particles) in the outer circumference reaches a saturated concentration faster than that in the center portion, so that the metal ink F increases its viscosity from the outer edge of the surface. The metal ink having the viscosity increased at the outer edge stops itself from spreading along a surface direction of the green sheet 4G (performs pinning). The metal ink F that has been pinned is fixed onto the green sheet 4G. The outer diameter of the droplet Fb does not change. Therefore, even when the metal ink F is overlapped, the droplet Fb is not pulled toward a following droplet Fb.

The guiding member 25 is provided with a pair of upper and lower guide rails 28 extending along the arrow X direction at roughly whole width of the guiding member 25. On the pair of upper and lower guide rails 28, a carriage 29 is attached. The carriage 29 is guided by the guiding rails 28 and moves in the arrow X direction and a direction opposite to the arrow X direction.

A supporting plate 29A is disposed parallel to the stage 23 on a lower surface of the carriage 29. The supporting plate 29A has the droplet discharge head 30 provided thereon. The droplet discharge head 30 includes a head substrate 31 fixed to the supporting plate 29A in a manner extending in the Y direction and a head body 30A fixed to the head substrate 31 in the manner extending in the Y direction.

The head substrate 31 is positionally fixed onto the supporting plate 29A. Specifically, as shown in FIG. 3, the droplet discharge head 30 makes the discharge head body 30A to be penetrated from an upper surface 29Aa of the supporting plate 29A through a through-hole 32 penetrated in the plate 29A so that discharge head body 30A is protruded from a lower surface 29Ab of the supporting plate 29A. In the state where the discharge head body 30A is protruded from the lower surface 29Ab of the supporting plate 29A, the upper surface 29Aa of the supporting plate 29A is tightly fixed to the head substrate 31 to allow the droplet discharge head 30 to be supportedly fixed to the supporting plate 29A. Thereby, the droplet discharge head 30 moves together with the carriage 29 in the arrow X direction.

As shown in FIG. 3, the discharge head body 30A is provided with a nozzle plate 33 at a bottom surface thereof. The bottom surface (a nozzle forming surface 33a) of the nozzle plate 33 is formed roughly parallel to an upper surface (a discharge surface 4Ga) of the green sheet 4G. When the green sheet 4G is positioned directly below the discharge head 30, a predetermined distance (a platen gap, such as 600 micrometers) is maintained between the nozzle forming surface 33a and the discharge surface 4Ga.

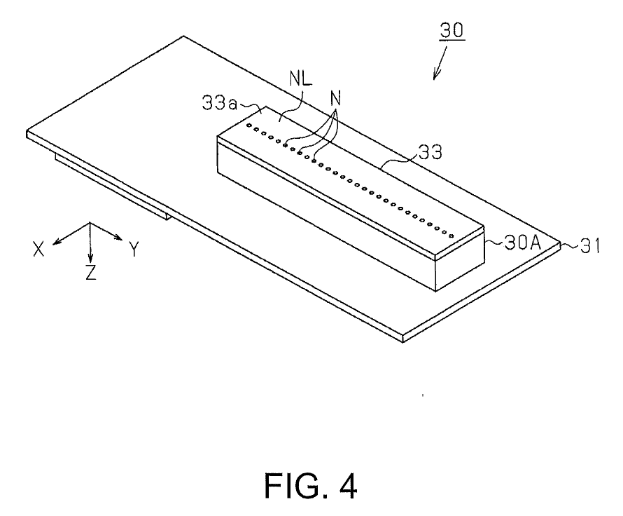

In FIG. 4, the nozzle forming surface 33a is provided with a nozzle row NL composed of a plurality of nozzles N arranged along the arrow Y direction. Each nozzle row of a pair of nozzle rows NL has 180 nozzles N per inch.

In FIG. 3, a supply tube 30T is connected to an upper side of the discharge head 30. The supply tube 30T is set extending in an arrow Z direction. The supply tube 30T supplies the discharge head 30 with the metal ink F from the ink tank 26.

A cavity 34 communicating with the supply tube 30T is formed on an upper side of each nozzle N. The cavity 34 stores the metal ink F from the supply tube 30T and supplies the corresponding nozzle N with the metal ink F.

A vibrating plate 35 is bonded to an upper side of the cavity 34. The vibrating plate 35 vibrates in a vertical direction and increases and decreases the volume within the cavity 34. A piezoelectric element PZ corresponding to the nozzle N is set on an upper side of the vibrating plate 35. The piezoelectric element PZ contracts and expands in the vertical direction, and vibrates the vibrating plate 35 in the vertical direction. The vibrating plate 35 that vibrates in the vertical direction forms the metal ink F into the droplet Fb of a predetermined size and discharges the droplet Fb from the corresponding nozzle N. The discharged droplet Fb flies from the corresponding nozzle N in a direction opposite to the arrow Z direction and lands on the discharge surface 4Ga of the green sheet 4G.

A pair of moisture adsorption devices 40 as moisture adsorption components is disposed on a lower surface 29Ab of the supporting plate 29A. The moisture adsorption devices 40 are disposed on one side of the discharge head body 30A in the arrow X direction and the other side of the discharge head body 30A in the opposite direction to the arrow X direction. The moisture adsorption device 40 is composed of a rectangular parallelepiped container 41 and moisture adsorption particles 42 stored in the container 41.

The container 41 is made of stainless steel having a number of air holes (not shown) penetrated therein. The air hole is formed in a size that prevents the stored moisture adsorption particles 42 from falling out. The container 41 is removably fixed to the supporting plate 29A with screws (not shown). The moisture adsorption particles 42 are made of silica gel. The moisture contained in the air that is flown into the container 41 through a number of air holes adsorb to the container 41.

Next, a method of forming a wiring line pattern on the green sheet 4G using the droplet discharge device 20 will be described. As shown in FIG. 2, the green sheet 4G is placed on the stage 23 so that the discharge surface 4Ga facing upward. At this time, the stage 23 disposes the green sheet 4G in the direction opposite to the arrow Y direction with respect to the carriage 29. The via holes 7 are formed on the green sheet 4G. The via wiring lines 8 are laid through the via holes 7, thereby forming the internal wiring lines 6 on the discharge surface 4Ga.

The rubber heater H provided on the stage 23 is driven, and the green sheet 4G placed on the stage 23 is heated to a predetermined temperature. Steam is produced from the green sheet 4G by heat, resulting in a condition in which the steam stays on the surface of the green sheet 4G.

The stage 23 is carried so that the droplet discharge head 30 passes through directly above a predetermined position of the green sheet 4G in the arrow X direction. Then the droplet discharge head 30 starts scanning (reciprocating). The scanning (reciprocating) of the discharge head 30 allows the droplet discharge device 20 discharging the droplet Fb from a selected nozzle N, as shown in FIG. 3, each time at which the discharge head 30 is positioned over a landing position which is used to form the internal wiring lines 6. The discharged droplet Fb lands sequentially to the landing position of the internal wiring lines 6 to be formed.

The discharge head 30 reciprocates on the green sheet 4G in the arrow X direction while discharging the droplet Fb so as to pass through the steam staying on the surface of the heated green sheet 4G. At this time, the moisture adsorption devices 40 disposed on the sides of the discharge head 30 in the moving direction and the opposite direction to the moving direction also pass through the steam staying on the surface of the green sheet 4G.

The moisture in the steam adsorb to the moisture adsorption particles 42 stored in the container 41 as the moisture adsorption device 40 passes through the steam staying on the surface. As a result, the surface of the green sheet 4G is dried.

Therefore, drying the droplet Fb which is discharged from the discharge head 30 and landed on the green sheet 4G can be accelerated since the surface of the green sheet 4G is in the dry condition. When the discharge head 30 completes scanning from one edge of the green sheet 4G to the other, in other words, when the discharge head 30 scans (reciprocates) in the arrow X direction and a first time droplet Fb operation is completed, the discharge head 30 starts scanning in the direction opposite to the arrow X direction (reciprocating) after the stage 23 is carried a predetermined distance in the arrow Y direction so that the droplet Fb is discharged onto a new position on the green sheet 4G to form the internal wiring lines 6.

The scanning (reciprocating) of the discharge head 30 enables the droplet discharge device 20, as described above, to discharge the droplet Fb from a selected nozzle N each time at which the discharge head 30 is positioned over a landing position used to form the internal wiring lines 6.

When the discharge head 30 reciprocates on the green sheet 4G in the direction opposite to the arrow X direction while discharging the droplet Fb, it also passes through the steam staying on the surface of the green sheet 4G. At this time, as described above, the moisture of the steam staying on the surface adsorb to the moisture adsorption particles 42 stored in the container 41 of the moisture adsorption device 40. As a result, the surface of the green sheet 4G is dried.

Therefore, drying the droplet which is discharged from the discharge head 30 and landed on the green sheet 4G can be accelerated since the surface of the green sheet 4G is in the dry condition. Subsequently, operations are repeated in which the discharge head 30 reciprocates in the arrow X direction and the direction opposite to the arrow X direction while the stage 23 is carried in the arrow Y direction, and the droplets Fb are discharged at a predetermined timing onto the green sheet 4G while the discharge head 30 reciprocates. As a result, a wiring line pattern is drawn on the green sheet 4G with the landed droplets Fb to form the internal wiring lines 6.

Advantageous effects according to the embodiment configured as described above will be described below. According to the above described embodiment, the rubber heater H is provided on the stage 23, and the green sheet 4G placed on the stage 23 is heated to a predetermined temperature. Therefore, the droplet discharged from the discharge head 30 and landed on the green sheet 4G is dried rapidly.

According to the above described embodiment, the moisture adsorption devices 40 are disposed on the sides of the discharge head body 30A in the arrow X direction and in the opposite direction to the arrow X direction. The moisture adsorption device 40 is composed of the moisture adsorption particles 42 stored in the container 41. The steam which is produced from the green sheet 4G and stays on the surface of the green sheet 4G prevents the landed droplet Fb from drying. The steam adsorbs to the moisture adsorption device 40 so that the surface of the green sheet 4G is dried. In addition, the steam adsorbs to the moisture adsorption device 40 when the moisture adsorption device passes through the steam staying on the surface of the green sheet 4G. It enables the surface of the green sheet 4G to be into the dry condition efficiently.

Therefore, drying the droplet Fb which is discharged from the discharge head 30 and landed on the green sheet 4G can be accelerated. According to the above described embodiment, the moisture adsorption devices 40 are disposed on the sides of the discharge head body 30A in the arrow X direction and in the opposite direction to the arrow X direction. Therefore, the moisture adsorption device 40 can be passed through a position before the droplet Fb landed or after landed with a simple structure. The landed droplet Fb can be dried efficiently and securely.

The above mentioned embodiment may be changed as followings. According to the above described embodiment, the moisture adsorption devices 40 are disposed on the sides of the discharge head body 30A in the arrow X direction and in the opposite direction to the arrow X direction. The moisture adsorption device 40 may be disposed on only one of the sides of the discharge head body 30A or to surround all four sides of the discharge head body 30A. Furthermore, the moisture adsorption device 40 may be disposed on a whole surface of the supporting plate 29 except for an area where the discharge head 30 is protruded.

The moisture adsorption particles 42 stored in the container 41 of the moisture adsorption device 40 are made of silica gel in the above mentioned embodiment. However, any of that can absorb and hold moisture, and can be disposed adjacent to the discharge head body 30A may be used instead of silica gel.

According to the embodiment, the functional liquid is realized by the metal ink F. The functional liquid is not limited to it, and, for example, can be a functional liquid including a liquid crystal material. In other words, the functional liquid is only required to be that which can be discharged to form a pattern.

In the above embodiment, the substrate is embodied as the green sheet 4G. The substrate is not limited to it and, for example, can be a glass substrate, a polyimide substrate, a glass epoxy substrate, and the like. Furthermore, in the embodiment, droplet discharge means is embodied as the droplet discharge head 30 using a piezoelectric element driving system. Other than that, for example, the droplet discharge head may be embodied as a discharge head using a resistance heating system or an electrostatic driving system.

The entire disclosure of Japanese Patent Application No. 2008-12296, filed Jan. 23, 2008 is expressly incorporated by reference herein.

What is claimed is:

1. A droplet discharge device, comprising:
a droplet discharge head attached to a carriage;
a stage placing a substrate thereon; and
a moisture adsorption device disposed adjacent to the droplet discharge head, wherein a droplet of a functional liquid containing a functional material is sequentially discharged from the droplet discharge head to the substrate so as to draw a pattern on a surface of the substrate while the droplet discharge head moves relative to the substrate.

2. The droplet discharge device according to claim 1, wherein the moisture adsorption device is disposed adjacent to one of a first side of the droplet discharge head in a droplet discharge head relative movement direction and a second side of the droplet discharge head in a direction opposite to the droplet discharge head relative movement direction.

3. The droplet discharge device according to claim 1, wherein a heating unit for heating the substrate is provided on the stage.

4. The droplet discharge device according to claim 1, wherein the substrate is a low-temperature firing sheet includes ceramic particles and resin, and the functional liquid is a metal ink liquid in which dispersed metal particles serving as the functional material.

5. The droplet discharge device according to claim 1, wherein the moisture adsorption device includes a container having air holes and moisture adsorption particles stored in the container.

6. The droplet discharge device according to claim 5, wherein the moisture adsorption particles are made of silica gel.
